(19) United States
(12) Patent Application Publication
(10) Pub. No.: US 2026/0364648 A1
(43) Pub. Date: Nov. 19, 2026

(54) AIR FRYER, AIR FRYING DEVICE, COOKING DEVICE, AND CLEANING METHOD THEREFOR

(71) Applicant: Shenzhen Typhur Technology Co., Ltd, Shenzhen (CN)

(72) Inventors: Xiang WEI, Shenzhen (CN); Tao HU, Shenzhen (CN)

(21) Appl. No.: 19/142,642

(22) PCT Filed: Oct. 26, 2022
(86) PCT No.: PCT/CN2022/127799

§ 371 Date: Jun. 24, 2025

(51) Int. Cl. B08B 7/00; A47J 36/02; A47J 36/32; A47J 37/06

(52) U.S. Cl. CPC B08B 7/0071; A47J 36/02; A47J 36/32; A47J 37/0641

(57) ABSTRACT

An air fryer, an air frying and baking device, a cooking device, and a cleaning method therefor. The cleaning method comprises: receiving a cleaning instruction; and in response to the cleaning instruction, controlling a heating and air supply component (50) of an air fryer to work according to a cleaning temperature, at least part of the inner wall of a cooking chamber (11) of the air fryer is coated with a cleaning layer (11a), the cleaning layer (11a) is used for adsorbing oil stains generated in a cooking process, and the oil stains can be catalytically decomposed when the heating and air supply component (50) works according to the cleaning temperature.

### TECHNICAL FIELD

The present invention relates to the field of food cooking appliances, specifically to an air fryer, an air frying and baking device, a cooking device, and their cleaning method.

### BACKGROUND ART

With the improvement of people's living standards, cooking appliances such as air fryers have become increasingly popular and widely used. An air fryer primarily utilizes hot air to replace the oil traditionally used in a frying pan, cooking the food. In this process, the hot air blows away the moisture on the surface of the food, achieving a result similar to deep frying, thus realizing “air frying.”

Because the air fryer uses hot air for cooking, food oil stains tend to accumulate easily on the top during cooking. Due to the presence of the heating element on the top, it is difficult for users to clean, resulting in the gradual buildup of food oil stains. These stains are repeatedly heated and melted during cooking, and their melted byproducts may either be expelled outside or fall onto the food, potentially affecting the user's health and safety. Additionally, the stubborn oil stains on the top also impact the user's cooking experience.

Currently, the problem of difficult cleaning inside the air fryer remains unresolved.

### SUMMARY OF THE INVENTION

To address the aforementioned issues, the present invention primarily provides an air fryer, an air frying and baking device, a cooking device, and their cleaning method. Below is a detailed description.

According to the first aspect, one embodiment of the invention provides an air fryer, which has an initial cleaning mode and a deep cleaning mode. The air fryer includes:

Air fryer body: The air fryer body has a cooking chamber. At least part of the inner wall of the cooking chamber is coated with a cleaning layer, which is configured to absorb oil stains generated during the cooking process. The cleaning layer also acts as a catalyst to increase the reaction rate of the cleaning reaction under conditions greater than a first temperature, where the cleaning reaction includes the decomposition of the absorbed oil stains;

Heating and air supply component, configured to supply hot air to the cooking chamber for cooking;

Operation panel defined on the air fryer body. The operation panel includes a start button and a cleaning button;

Controller configured to control the operation of the heating and air supply component;

In response to a state of the start button, the controller controls the heating and air supply component to operate according to the cooking temperature to carry out cooking. Additionally, in response to a turn-on state of the start button, the initial cleaning mode is automatically activated: the cleaning layer absorbs the oil stains generated during cooking, and acts as a catalyst to facilitate the cleaning reaction to decompose the oil stains. The cooking temperature is less than the first temperature;

In response to a state of the cleaning button, the controller starts the deep cleaning mode: it controls the heating and air supply component to operate for a preset duration based on the cleaning temperature to carry out the cleaning. The cleaning temperature is not less than the first temperature, so that the cleaning layer acts as a catalyst to catalyze the cleaning reaction and decompose the oil stains.

According to the second aspect, one embodiment of the invention provides an air frying and baking device, which has a self-cleaning mode. The air frying and baking device includes:

The air frying and baking device body includes a cooking chamber; at least part of the inner wall of the cooking chamber is coated with a cleaning layer. The cleaning layer is configured to absorb oil stains generated during cooking and can catalyze the decomposition of the absorbed oil stains;

Heating and air supply component configured to supply hot air to the cooking chamber for cooking;

Operation panel defined on the air frying and baking device body. The operation panel includes a start button and a cleaning button;

Controller configured to control the operation of the heating and air supply component;

In response to a state of the start button, the controller controls the heating and air supply component to work based on the cooking temperature for cooking;

In response to a state of the cleaning button, the controller starts the self-cleaning mode: it controls the heating and air supply component to work for a preset duration based on the cleaning temperature to clean, catalyzing the decomposition of the absorbed oil stains.

The cooking temperature is not greater than the cleaning temperature.

One embodiment provides a cooking device, including:

Cooking device body including a cooking chamber. At least part of the inner wall of the cooking chamber is coated with a cleaning layer, which is configured to absorb oil stains generated during cooking and can catalyze the decomposition of the oil stains;

Cooking component configured to cook the food placed in the cooking chamber;

Controller configured to control the cooking component. When the controller controls the cooking component based on the cleaning temperature, it enables the cleaning layer to catalyze the decomposition of the oil stains for cleaning.

One embodiment provides a cleaning method for an air fryer, including:

Providing an initial cleaning mode and a deep cleaning mode. At least part of the inner wall of the air fryer's cooking chamber is coated with a cleaning layer;

Upon receiving the start instruction: in response to the start instruction, the controller controls the air fryer's heating and air supply component to operate according to the cooking temperature for cooking. Additionally, in response to the start instruction, the initial cleaning mode is activated: the cleaning layer absorbs oil stains generated during cooking and acts as a catalyst to initiate a cleaning reaction to decompose the oil stains. The cooking temperature is less than the first temperature;

Upon receiving the cleaning instruction: in response to the cleaning instruction, the deep cleaning mode is activated: the controller controls the air fryer's heating and air supply component to operate for a preset duration based on the cleaning temperature, where the cleaning temperature is not less than the first temperature, allowing the cleaning layer to act as a catalyst to decompose the oil stains.

One embodiment provides a cleaning method for an air fryer, including:

Receiving the cleaning instruction;

In response to the cleaning instruction, the controller controls the air fryer's heating and air supply component to work according to the cleaning temperature. At least part of the inner wall of the air fryer's cooking chamber is coated with a cleaning layer, which is configured to absorb oil stains generated during cooking and can catalyze the decomposition of the oil stains when the heating and air supply component operates based on the cleaning temperature;

According to the sixth aspect, one embodiment provides an air fryer, including:

Air fryer body has a cooking chamber. At least part of the inner wall of the cooking chamber of the air fryer is coated with a cleaning layer, which is configured to absorb oil stains generated during cooking and can catalyze the decomposition of the oil stains; Heating and air supply component configured to supply hot air to the cooking chamber for cooking;

Memory configured to store programs;

Processor configured to execute the program stored in the memory to implement the method described in any of the embodiments of this document.

According to the seventh aspect, one embodiment provides a computer-readable storage medium, including a program, where the program can be executed by a processor to implement the method described in any of the embodiments of this document.

### BRIEF DESCRIPTION OF THE DRAWINGS

FIG. 1 is a structural schematic of the cooking device, such as an air frying and baking device, in one embodiment.

FIG. 2 is a structural schematic of the cooking device, such as an air frying and baking device, in one embodiment.

FIG. 3 is a structural schematic of the cooking device, such as an air frying and baking device, in one embodiment.

FIG. 4 is a structural schematic of the cooking device, such as an air frying and baking device, in one embodiment.

FIG. 5 is a structural schematic of the cooking device, such as an air frying and baking device, in one embodiment.

FIG. 6 is a structural schematic of the cooking device, such as an air frying and baking device, in one embodiment.

FIG. 7 is a structural schematic of the operation panel in one embodiment.

FIG. 8 is a flowchart of the cleaning method of the cooking device, such as an air frying and baking device, in one embodiment.

FIG. 9 is a flowchart of the cleaning method of the cooking device, such as an air frying and baking device, in one embodiment.

FIG. 10 is a flowchart of the cleaning method of the cooking device, such as an air frying and baking device in one embodiment.

FIG. 11 is a structural schematic of the cooking device in one embodiment.

### DETAILED DESCRIPTION OF THE EMBODIMENTS

The following provides a further detailed explanation of the present invention through specific embodiments and with reference to the accompanying drawings. Similar components in different embodiments are assigned corresponding reference numerals. In the following embodiments, many details are provided to ensure better understanding of this application. However, those skilled in the art will readily recognize that some features can be omitted in different circumstances or can be replaced by other components, materials, or methods. In certain cases, some operations related to this application are not shown or described in the specification to avoid overwhelming the core aspects of this application with excessive detail. However, for those skilled in the art, it is not necessary to describe these related operations in detail, as they can fully understand the operations from the description in the specification and from common technical knowledge in the field.

Additionally, the features, operations, or characteristics described in the specification can be combined in any suitable manner to form various embodiments. Moreover, the steps or actions described in the method can be rearranged or adjusted in sequence in ways that would be obvious to those skilled in the art. Therefore, the various sequences in the specification and drawings are merely provided for clarity in describing a particular embodiment and do not imply any mandatory order unless explicitly stated.

The numbering of components in this document, such as “first,” “second,” etc., is used solely to distinguish the objects being described and does not imply any sequence or technical significance. The terms “connect” or “couple,” unless specifically stated otherwise, include both direct and indirect connections (or couplings).

Cooking devices, such as air fryers, are prone to the deposition of oil stains and food residues on their tops, which makes them unhygienic after prolonged use. Cooking devices, such as ovens, can self-clean through high-temperature carbonization or steam cleaning. In some configurations, cooking devices, such as ovens, can also clean the cavity walls by catalytically oxidizing.

Typically, high-temperature carbonization requires temperatures ranging from 400 °C to 500 °C, which is not achievable for air frying and baking devices, especially air fryers. This is because air fryers, being relatively compact, face significant challenges in heat dissipation when temperatures reach 400 °C to 500 °C, and such temperatures could easily damage the device. Moreover, catalytic oxidation generally requires a special coating on the inner walls and needs high temperatures, such as 230 °C, 250 °C, or even 260 °C, to effectively decompose oil stains. Similarly, air fryers cannot achieve such high-temperature power.

Due to the general temperature limit of around 200 °C and the lack of steam systems, air fryers cannot achieve self-cleaning functions. Therefore, existing air fryers do not have self-cleaning capabilities.

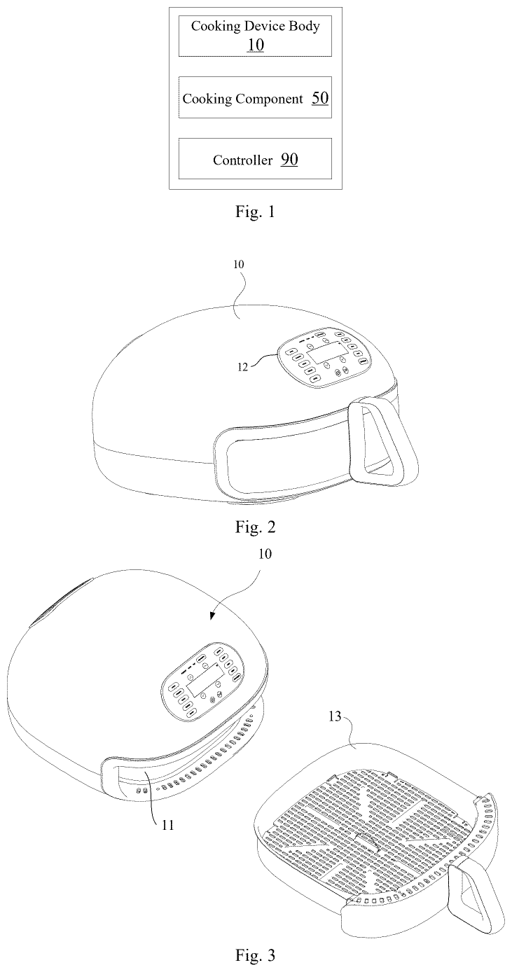

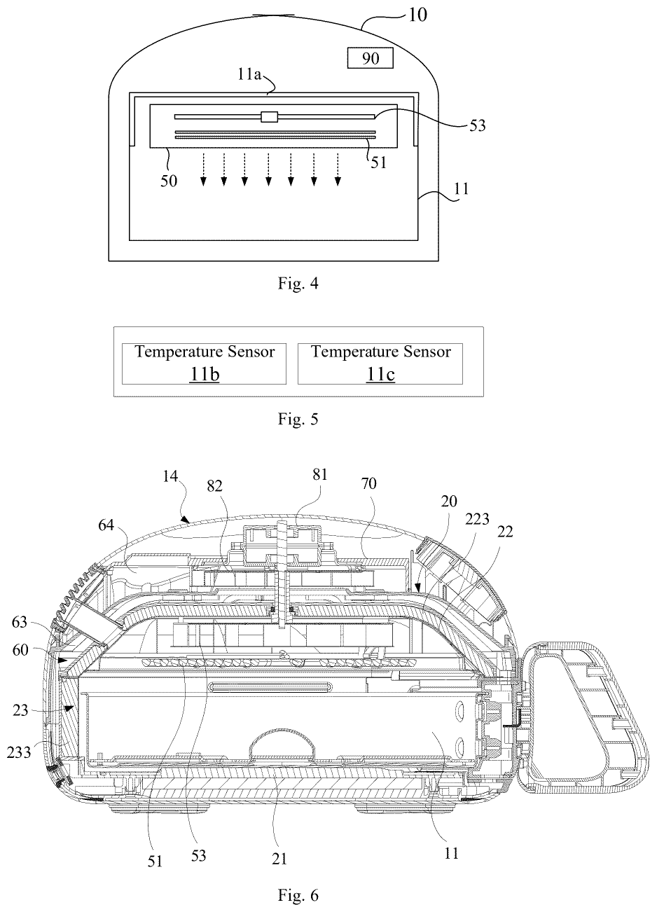

Refer to FIGS. 1 to 4, where some embodiments of the cooking device include a cooking device body 10, a cooking component 50, and a controller 90. The cooking device body 10 has a cooking chamber 11. At least part of the inner wall of the cooking chamber 11 is coated with a cleaning layer 11a. The cleaning layer 11a is configured to absorb oil stains, such as oil stains or grease, generated during cooking and can catalyze the decomposition of these oil stains, such as breaking them down into water and carbon dioxide, as further explained below. The cooking component 50 is configured to cook the food placed in the cooking chamber 11. The controller 90 is configured to control the operation of the cooking component 50. In some embodiments, when the controller 90 controls the cooking component 50 based on the cleaning temperature, it can enable the cleaning layer 11a to catalyze the decomposition of these oil stains, such as oil stains, to facilitate cleaning.

In some embodiments, the cooking device can be the cooking device which is capable of air frying and baking, such as an air frying and baking device or other device capable of air frying and baking, the air frying and baking device may be an air fryer, an air oven, etc.

In some embodiments, the cooking device can be an air frying and baking device, and accordingly, the cooking device body 10 is an air frying and baking device body 10, with the cooking component 50 being a heating and air supply component 50. In some embodiments, when the air frying and baking device is an air fryer, the cooking device body 10 is the air fryer body 10.

The air frying and baking device body 10 includes a cooking chamber 11. In some embodiments, the cooking chamber 11 is configured to place food to be cooked. It should be noted that the cooking chamber 11 can be used for direct or indirect placement of food. For example, food can be placed in the cooking chamber 11 via a removable basket 13, as shown in FIG. 3. The air frying and baking device may be an air fryer, an air oven, etc.

In some embodiments, at least part of the inner wall of the cooking chamber 11 is coated with a cleaning layer 11a.

In some embodiments, the cleaning layer 11a is configured to absorb oil stains, such as oil stains, generated during cooking and can catalyze the decomposition of the absorbed oil stains, such as breaking them down into water and carbon dioxide.

In some embodiments, the cleaning layer 11a is configured to absorb oil stains generated during cooking and acts as a catalyst to increase the reaction rate of the cleaning reaction at temperatures higher than a first temperature, with the cleaning reaction including the decomposition of the absorbed oil stains, such as breaking them down into water and carbon dioxide.

In some embodiments, the heating and air supply component 50 is located beneath the top wall of the cooking chamber 11, with at least the top wall of the cooking chamber 11 being coated with the cleaning layer 11a.

In some embodiments, the thickness of the cleaning layer 11 a is from 10 μm to 1000 μm.

In some embodiments, the cleaning layer 11a has a porous structure, which makes it easier to adsorb oil stains or grease generated during cooking.

In some embodiments, the cleaning layer 11a comprises at least one metal selected from copper, vanadium, bismuth, molybdenum, manganese, iron, nickel, at platinum group metals, tin, and niobium, chromium, tungsten, rhenium, cobalt, and cerium, along with oxides of these metals and compounds composed of two or more of these metals and oxides.

The heating and air supply component 50 is configured to supply hot air to the cooking chamber 11 for cooking. The heating and air supply component 50 works by heating the air and blowing the hot air (hot wind) towards the food in the cooking chamber 11 for cooking. In some embodiments, the heating and air supply component 50 includes a heating element 51 and an air supply element 53. The heating element 51 generates heat when powered to heat the air, and the air supply element 53 blows the heated air towards the food in the cooking chamber 11. In some embodiments, the heating element 51 may be realized using a heating tube. In some embodiments, the air supply element 53 may be realized using a fan. To achieve better air frying results, the heating and air supply component 50 can be positioned below the top wall of the cooking chamber 11, specifically, the air supply element 53 and the heating element 51 are sequentially arranged below the top wall of the cooking chamber 11, such that the air supply element blows air downwards, which passes through the heating element 51 and then reaches the food placed at the bottom wall of the cooking chamber 11.

The controller 90 is configured to control the operation of the heating and air supply component 50. In some embodiments, the controller 90 controls the operation of the heating and air supply component 50 based on parameters such as temperature and/or airflow speed. The temperature can be the cooking temperature or the cleaning temperature, as mentioned in this application.

In some embodiments, refer to FIG. 5. The air frying and baking device may include one or more sensors, such as a temperature sensor 11b positioned near the heating element 51 and/or a temperature sensor 11c located at a preset position within the cooking chamber 11. These sensors will be further described below.

Temperature parameters can be represented by one or more of the current, voltage, or power of the heating element 51. The temperature parameters of the heating element 51can also be represented by the temperature of the heating element 51. The cooking temperature can be represented by the temperature inside the cooking chamber 11, for example, by placing a temperature sensor 11b near the cleaning layer 11a to obtain the temperature of the heating element 51. The controller 90 can adjust the drive current and/or drive voltage of the heating element 51 based on the temperature feedback from the temperature sensor 11b, thereby maintaining the temperature near the cleaning layer 11a at the desired temperature. Similarly, by placing a temperature sensor 11c at a preset position in the cooking chamber 11, the temperature inside the cooking chamber 11 can be monitored. The controller 90 can adjust the drive current and/or drive voltage of the heating element 51 based on the temperature feedback from the temperature sensor 11c, thereby maintaining the temperature inside the cooking chamber 11 at the desired temperature.

Therefore, when the controller 90 controls the operation of the heating and air supply component 50 based on the temperature parameters, it means that the temperature parameter is adjusted to reach the expected value.

The cooking temperature can be represented by the temperature inside the cooking chamber 11. When the controller 90 controls the operation of the heating and air supply component 50 based on the cooking temperature, it means that the temperature inside the cooking chamber 11 reaches the specified cooking temperature. For example, for a cooking temperature of 160 °C, the controller 90 controls the heating and air supply component 50 to ensure that the temperature inside the cooking chamber 11 reaches 160 °C. Similarly, for a cooking temperature of 200 °C, the controller 90 controls the heating and air supply component 50 to ensure that the temperature inside the cooking chamber 11 reaches 200 °C. For a cooking temperature of 230 °C, the controller 90 controls the heating and air supply component 50 to ensure that the temperature inside the cooking chamber 11 reaches 230 °C.

In some embodiments, the cleaning temperature can be represented by the temperature near the cleaning layer 11a. The controller 90 controls the operation of the heating and air supply component 50 to maintain the temperature near the cleaning layer 11a at the desired cleaning temperature.

In some embodiments, the air frying and baking device, such as an air fryer, can achieve very high temperatures. For example, during cooking, the temperature inside the cooking chamber 11 can reach over 200 °C, such as over 220 °C, over 230 °C, over 250 °C, over 260 °C, or even over 280 °C.

In some embodiments, the air frying and baking device, such as an air fryer, achieves excellent heat insulation and heat dissipation effects by improving its structure, thus enabling it to reach very high temperatures.

Referring to FIG. 6, in some embodiments, the cooking device body 10 includes a shell 14 and a partition structure 20. The partition structure 20 is placed inside the shell 14 to form the cooking chamber 11. The cooking device body 10 also forms a heat dissipation air channel 60, which includes an air flow channel 63 and a guiding flow channel 64. The shell 14 and the partition structure 20 cooperate to form the air flow channel 63, and the guiding flow channel 64 communicates with the air flow channel 63. The cooking device body 10 also includes a guiding cover 70, which is connected to the partition structure 20 and cooperates with it to form a spiral guiding flow channel 64. This spiral shape, similar to a snail shell, helps to increase the pressure of the gas drawn into the guiding flow channel 64, enhancing the flow rate of the cold air inside the guiding flow channel 64, which quickly carries away heat. In some embodiments, the cooking device may be an air frying and baking device. Accordingly, in this case, the cooking device body 10 is an air frying and baking device body 10, and the cooking component 50 is a heating and air supply component 50. In some embodiments, when the air frying and baking device is an air fryer, the cooking device body 10 is the air fryer body 10.

In some embodiments, the cooking device further includes a driving element 81 and a cold air fan 82. The driving element 81 is arranged on at least one of the partition structure 15 and the guiding cover 70. The cold air fan 82 is mechanically connected to the driving element 81, and at least one of the cold air fan 82 and the controller 90 is placed within the guiding flow channel 64. The cold air fan 82, when driven by the driving element 81, accelerates the airflow speed in both the guiding flow channel 64 and the heat dissipation air channel 60, thereby achieving better heat dissipation. Additionally, when the cold air fan 82 operates, the cold air in the air flow channel 63 can also reduce the heat conduction or radiation to the controller 90 inside the cooking chamber 11, thereby lowering the temperature of the controller 90. In some embodiments, the cooking device may be an air frying and baking device, the air frying and baking device may be an air fryer.

In some embodiments, the partition structure 20 includes a bearing element 21, a first heat insulation element 22, and a second heat insulation element 23. Both ends of the second heat insulation element 23 are connected to the bearing element 21 and the first heat insulation element 22. The bearing element 21, the first heat insulation element 22, and the second heat insulation element 23 cooperate to form the cooking chamber 11, with the bearing element 21 serving as the bottom wall of the inner cavity of the cooking chamber 11. At least one of the first heat insulation element 22 and the second heat insulation element 23 is provided with a heat-insulating layer. The arrangement of the first heat insulation element 22 and the second heat insulation element 23 reduces the heat conduction or radiation from the cooking chamber 11 to the outside of the partition structure 20, thus preventing components outside the partition structure 20, such as the controller 90 and the shell 14, from overheating, improving the lifespan of these components and preventing the shell 14 from causing burns to the user due to excessive temperatures. Additionally, this arrangement reduces excessive heat loss from the cooking chamber 11, thus improving energy efficiency. The heat-insulating layer increases the thermal resistance of the partition structure 20, reducing the heat transfer from the cooking chamber 11 to the outside of the partition structure 20, preventing components outside the partition structure 20 from overheating, which improves the safety and longevity of both the components and the cooking device. It can be understood that the heat-insulating layer includes a first heat-insulating layer 223 and a second heat-insulating layer 233.

The following provides an explanation of how the device achieves self-cleaning.

In some embodiments, the controller 90 controls the heating and air supply component 50 to operate based on the cooking temperature for cooking. During cooking, the cleaning layer 11a can adsorb oil stains, such as oil stains or grease, generated during cooking. When the cooking temperature is low (i.e., not reaching the first temperature required for catalytic decomposition), the cleaning layer 11a will not catalyze the decomposition of the absorbed oil stains, such as oil stains or grease, or the efficiency of the cleaning layer 11a in catalyzing the decomposition of the oil stains is very low when the cooking temperature is low.

In some embodiments, the controller 90 controls the heating and air supply component 50 to operate based on the cleaning temperature (e.g., for a preset duration) for cleaning, thereby catalyzing the decomposition of the absorbed oil stains, such as oil stains or grease.

In some embodiments, the cooking temperature is lower than the first temperature.

In some embodiments, the cooking temperature is less than or equal to 260 °C

In some embodiments, the cooking temperature is greater than or equal to 230 °C and less than or equal to 260 °C.

In some embodiments, the cleaning temperature is not lower than the first temperature.

In some embodiments, the cleaning temperature is at least greater than or equal to 230 °C. In some embodiments, the cleaning temperature is 250 °C.

In some embodiments, the cleaning temperature is greater than or equal to 250 °C and less than or equal to 300 °C.

In some embodiments, the cleaning temperature is set so that the reaction rate for catalyzing the decomposition of oil stains, such as oil stains or grease, by the cleaning layer 11a is greater than the preset rate.

In some embodiments, the cooking temperature is not greater than the cleaning temperature.

In some embodiments, the preset duration is at least greater than or equal to 1 hour. In some embodiments, the preset duration is 2 hours.

In some embodiments, the controller 90 controls the heating and air supply component 50 to work for the preset duration for cleaning, including: controlling the heating and air supply component 50 to work continuously for the preset duration, or controlling the heating and air supply component 50 to work intermittently for the preset duration. For example, the controller 90 obtains the temperature inside the cooking chamber 11 through the temperature sensor 11c. When the temperature inside the cooking chamber 11 is greater than the maximum temperature threshold (e.g., 290 °C), the controller 90 controls the heating and air supply component 50 to stop working. Otherwise, the controller 90 will control the heating and air supply component 50 to continue or resume working.

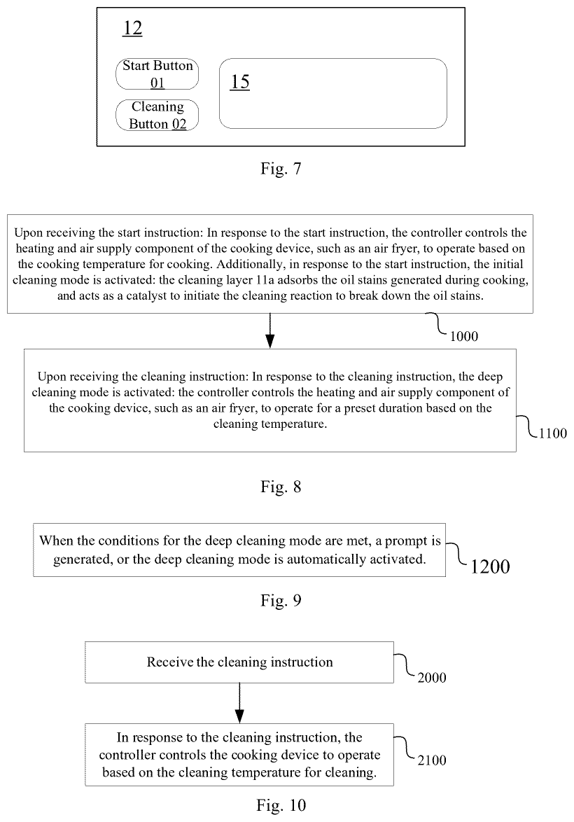

Referring to FIG. 7, in some embodiments, the cooking device includes an operation panel 12, which is installed on the cooking device body 10 for user operation. In some embodiments, the operation panel 12 may also include a display screen 15, which can display information such as remaining cooking time and temperature. It can be understood that some embodiments of the cooking device can be an air frying and baking device. Accordingly, the cooking device body 10 would be an air frying and baking device body 10, and the cooking component 50 would be a heating and air supply component 50. In some embodiments, when the air frying and baking device is an air fryer, the cooking device body 10 is the air fryer body 10.

In some embodiments, the operation panel 12 includes a start button 01 and/or a cleaning button 02.

In some embodiments, the operation panel 12 may be a touch panel, in which case it may include various buttons or virtual buttons.

In some embodiments, the cleaning button 02 corresponds to the self-cleaning mode, meaning the device has a self-cleaning mode.

In some embodiments, in response to a state of the start button 01, the controller 90 controls the heating and air supply component 50 to operate based on the cooking temperature for cooking.

In some embodiments, in response to a state of the cleaning button 02, the controller 90 initiates the self-cleaning mode: it controls the heating and air supply component 50 to work based on the cleaning temperature (e.g., for a preset duration) to perform cleaning, thereby catalyzing the decomposition of the absorbed oil stains, such as oil stains or grease.

In some embodiments, when the conditions for the self-cleaning mode are met, the controller 90 also generates a prompt, such as an audible or visual alert through the display screen 15, to remind the user that the self-cleaning function of the device needs to be activated.

In some embodiments, when the conditions for the self-cleaning mode are met, the controller 90 automatically activates the self-cleaning mode, i.e., the controller 90 controls the heating and air supply component 50 to work based on the cleaning temperature (e.g., for a preset duration) to perform cleaning, thereby catalyzing the decomposition of the absorbed oil stains, such as oil stains or grease.

In some embodiments, the conditions for the self-cleaning mode include at least one of the following: the number of cooking cycles reaching a preset count; the total cooking time reaching a preset duration; or the occurrence of a scheduled self-cleaning time point.

In some embodiments, the cooking device includes an initial cleaning mode and a deep cleaning mode. In some embodiments, the cooking device can be an air frying and baking device, such as an air fryer.

In some embodiments, in response to a state of the start button 01, the controller 90 controls the heating and air supply component 50 to operate based on the cooking temperature for cooking; additionally, in response to a state of the start button 01, the initial cleaning mode is automatically activated: the cleaning layer 11a adsorbs oil stains, such as oil stains or grease, generated during cooking, and acts as a catalyst to facilitate the cleaning reaction, breaking down the oil stains, such as oil stains or grease. In some embodiments, in response to a state of the cleaning button 02, the controller 90 activates the deep cleaning mode: it controls the heating and air supply component 50 to work for a preset duration based on the cleaning temperature for cleaning. In some embodiments, the cleaning temperature is no lower than the first temperature, enabling the cleaning layer to act as a catalyst, promoting the cleaning reaction and breaking down the oil stains.

The descriptions of the cooking temperature and cleaning temperature can be found above, and will not be reiterated here.

In some embodiments, when the conditions for the deep cleaning mode are met, the controller 90 also generates a prompt, such as an audible or visual alert through the display screen 15, to remind the user that the deep cleaning function of the device needs to be activated.

In some embodiments, when the conditions for the deep cleaning mode are met, the controller 90 automatically activates the deep cleaning mode, i.e., the controller 90 controls the heating and air supply component 50 to work based on the cleaning temperature (e.g., for a preset duration) to perform cleaning, thereby catalyzing the decomposition of the absorbed oil stains, such as oil stains or grease.

In some embodiments, the conditions for the deep cleaning mode include at least one of the following: the number of cooking cycles reaching a preset count; the total cooking time reaching a preset duration; or the occurrence of a scheduled deep cleaning time point.

In some embodiments, a cleaning method for a cooking device is also disclosed. The cooking device can be any of the cooking devices mentioned in this document, such as the air fryer, in which the inner wall 11 of the cooking chamber of the cooking device, such as the air fryer, is coated with the cleaning layer 11a.

Refer to FIG. 8. The cleaning method in some embodiments provides an initial cleaning mode and a deep cleaning mode, which can include the following steps:
Step 1000: Upon receiving the start instruction: In response to the start instruction, the controller controls the heating and air supply component of the cooking device, such as an air fryer, to operate based on the cooking temperature for cooking. Additionally, in response to the start instruction, the initial cleaning mode is activated: the cleaning layer 11a adsorbs the oil stains generated during cooking, and acts as a catalyst to initiate the cleaning reaction to break down the oil stains.

### In Some Embodiments, the Cooking Temperature Is Lower Than the First Temperature.

Step 1100: Upon receiving the cleaning instruction: In response to the cleaning instruction, the deep cleaning mode is activated: the controller controls the heating and air supply component of the cooking device, such as an air fryer, to operate for a preset duration based on the cleaning temperature. In some embodiments, the cleaning temperature is not lower than the first temperature, allowing the cleaning layer 11a of the cooking device, such as the air fryer, to act as a catalyst to facilitate the cleaning reaction and break down the oil stains.

In some embodiments, at temperatures greater than the first temperature, the cleaning layer 11a acts as a catalyst, causing the reaction rate of the cleaning reaction to exceed a preset rate.

In some embodiments, the cleaning method also includes Step 1200: When the conditions for the deep cleaning mode are met, a prompt is generated, or the deep cleaning mode is automatically activated.

In some embodiments, the conditions for the deep cleaning mode include at least one of the following: the number of cooking cycles reaching a preset count; the total cooking time reaching a preset duration; or the occurrence of a scheduled deep cleaning time point.

The descriptions of the cooking temperature, cleaning temperature, first temperature, preset duration, and cleaning layer 11a can be found in the above text and will not be reiterated here.

Refer to FIG. 10. The cleaning method in some embodiments includes the following steps:
Step 2000: Receive the cleaning instruction. For example, when the cleaning button 02 is triggered, a cleaning instruction is generated.

In some embodiments, when the first preset condition is met, the above cleaning instruction is generated. In some embodiments, the first preset condition includes at least one of the following: the cleaning button of the cooking device, such as the air fryer, being triggered; the number of cooking cycles reaching a preset count; the total cooking time reaching a preset duration; or the occurrence of a scheduled cleaning time point.

Step 2100: In response to the cleaning instruction, the controller controls the heating and air supply component of the cooking device, such as the air fryer, to operate based on the cleaning temperature for cleaning.

In some embodiments, the cleaning method also includes Step 2200: When the second preset condition is met, a prompt is generated to remind the user that the cooking device, such as the air fryer, needs cleaning. In some embodiments, the second preset condition includes at least one of the following: the number of cooking cycles reaching a preset count; the total cooking time reaching a preset duration; or the occurrence of a scheduled cleaning time point.

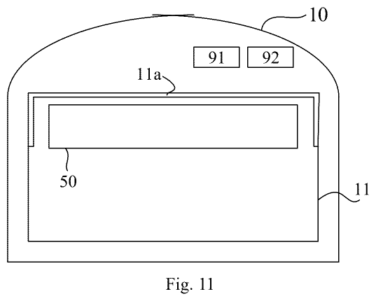

The descriptions of the cooking temperature, cleaning temperature, preset duration, and cleaning layer 11a can be found in the above text and will not be reiterated here. Refer to FIG. 11. In some embodiments, the cooking device includes a cooking device body 10, a cooking component 50, a memory 91, and a processor 92. The cooking device body 10 has a cooking chamber 11. At least part of the inner wall of the cooking chamber 11 is coated with a cleaning layer 11a, which is configured to adsorb oil stains, such as oil stains or grease, generated during cooking and can catalyze the decomposition of these oil stains, such as breaking them down into water and carbon dioxide. The cooking component 50 is configured to cook the food placed in the cooking chamber 11. In some embodiments, the cooking component 50 includes at least a heating element 51.

In some embodiments, the cooking device shown in FIG. 11 may be a device with air frying and baking functions, such as an air frying and baking device and other devices with air frying and baking capabilities. The air frying and baking device may include air fryers and air ovens. For example, when the cooking device is an air fryer, the cooking device body 10 is an air fryer body 10, and the cooking component 50 is a heating and air supply component 50.

The memory 91 is configured to store programs; the processor 92 is configured to execute the program stored in the memory 91 to implement the cleaning method described in any of the embodiments of this application.

This application has been described with reference to various exemplary embodiments. However, those skilled in the art will recognize that changes and modifications can be made to the exemplary embodiments without departing from the scope of this disclosure. For example, various operational steps and components configured to perform the operational steps can be implemented in different ways depending on the specific application or any number of cost functions related to the operation of the system. For instance, one or more steps can be omitted, modified, or combined with other steps.

In the above embodiments, all or part of the implementation may be achieved through software, hardware, firmware, or any combination thereof. Additionally, as understood by those skilled in the art, the principles of this document can be reflected in a computer-readable storage medium containing a computer program product, with the program code pre-installed on the medium. Any tangible, non-transitory computer-readable storage medium can be used, including magnetic storage devices (e.g., hard drives, floppy disks), optical storage devices (e.g., CD-ROM, DVD, Blu-ray discs), flash memory, and/or similar devices. These computer program instructions can be loaded onto a general-purpose computer, a dedicated computer, or other programmable data processing devices to form a machine, so that the instructions executed on a computer or other programmable data processing apparatus can generate a device to implement the specified functions. These computer program instructions can also be stored in a computer-readable memory, which can instruct the computer or other programmable data processing device to operate in a specific manner, allowing the instructions stored in the computer-readable memory to form a manufactured article, including a device that performs the specified function. The computer program instructions can also be loaded onto a computer or other programmable data processing device to execute a series of operational steps that generate a computer-implemented process, enabling the execution of instructions on a computer or other programmable device to provide the steps for implementing the specified function.

Although the principles of this disclosure have been illustrated in various embodiments, many modifications to the structure, arrangement, proportions, components, materials, and parts specifically suited to particular environments and operational requirements can be made without departing from the principles and scope of this disclosure. Such modifications, as well as other changes or alterations, are included within the scope of this disclosure.

The specific description above has been made with reference to various embodiments. However, those skilled in the art will recognize that various modifications and changes can be made without departing from the scope of this disclosure. Therefore, the scope of the invention should be determined solely by the claims.

1-56. (canceled)

57. A method for cleaning an air fryer, wherein comprising:
providing an initial cleaning mode and a deep cleaning mode; wherein at least part of an inner wall of the cooking chamber of the air fryer is coated with a cleaning layer;
receiving a start instruction: in response to the start instruction, controlling the heating and air supply component of the air fryer to operate based on the cooking temperature for cooking; and, in response to the start instruction, also activating the initial cleaning mode: the cleaning layer adsorbs oil stains generated during cooking, and acts as a catalyst to initiate the cleaning reaction to decompose the oil stains; the cooking temperature being less than a first temperature;
receiving a cleaning instruction: in response to the cleaning instruction, activating the deep cleaning mode: controlling the heating and air supply component of the air fryer to operate for a preset duration based on a cleaning temperature, the cleaning temperature being no less than the first temperature, so that the cleaning layer of the air fryer acts as a catalyst to catalyze the cleaning reaction to decompose the oil stains.

58. The cleaning method according to claim 57, wherein the cleaning layer acts as a catalyst to make the reaction rate of the cleaning reaction greater than a preset rate, when the temperature is greater than the first temperature.

59. The cleaning method according to claim 57, wherein further comprising:
generating a prompt, or automatically activating the deep cleaning mode, when it is determined that conditions for the deep cleaning mode are met.

60. The cleaning method according to claim 59, wherein the conditions for the deep cleaning mode comprise at least one of the following:
a number of cooking cycles reaching a preset count;
a total cooking time reaching a preset duration;
a scheduled deep cleaning time point being reached.

61. The cleaning method according to claim 57, wherein the first temperature is at least greater than or equal to 230 °C.

62. (canceled)

63. The cleaning method according to claim 57, wherein the preset duration is at least greater than or equal to 1 hour.

64. (canceled)

65. The cleaning method according to claim 57, wherein a thickness of the cleaning layer is from 10 μm to 1000 μm.

66. (canceled)

67. The cleaning method according to claim 57, wherein the cleaning layer comprises at least one metal selected from copper, vanadium, bismuth, molybdenum, manganese, iron, nickel, at platinum group metals, tin, and niobium, chromium, tungsten, rhenium, cobalt, and cerium, along with oxides of these metals and compounds composed of two or more of these metals and oxides.

68. (canceled)

69. The cleaning method according to claim 57, wherein the heating and air supply component is positioned beneath the top wall of the cooking chamber; at least the top wall of the cooking chamber is coated with the cleaning layer.

70. A method for cleaning an air fryer, wherein it comprises:
receiving a cleaning instruction;
in response to the cleaning instruction, controlling the heating and air supply component of the air fryer to operate based on a cleaning temperature; wherein at least part of an inner wall of the cooking chamber of the air fryer is coated with a cleaning layer, the cleaning layer being configured to adsorb oil stains generated during cooking, and capable of catalyzing the decomposition of the oil stains when the heating and air supply component operates based on the cleaning temperature.

71. The cleaning method according to claim 70, wherein it further comprises:
generating the cleaning instruction, when it is determined that a first preset condition is met; the first preset condition comprising at least one of the following:
a cleaning button of the air fryer being triggered;
a number of cooking cycles reaching a preset count;
a total cooking time reaching a preset duration;
a scheduled cleaning time point being reached.

72. The cleaning method according to claim 70, wherein further comprising:
when it is determined that the second preset condition is met, generating a prompt to remind the air fryer needs cleaning; the second preset condition comprising at least one of the following:
a number of cooking cycles reaching a preset count;
a total cooking time reaching a preset duration;
a scheduled cleaning time point being reached.

73. The cleaning method according to claim 70, wherein the cleaning temperature is at least greater than or equal to 230 °C.

74. The cleaning method according to claim 71, wherein the cleaning temperature makes the reaction rate of the cleaning layer catalyzing the decomposition of the oil stains greater than a preset rate.

75. The cleaning method according to claim 74, wherein the cooking temperature is greater than or equal to 230 °C and less than or equal to 260 °C.

76. The cleaning method according to claim 70, wherein, in response to the cleaning instruction, the controller controls the heating and air supply component of the air fryer to operate for a duration based on the cleaning temperature, and the duration is at least greater than or equal to 1 hour.

77. The cleaning method according to claim 70, wherein a thickness of the cleaning layer is from 10 μm to 1000 μm.

78. (canceled)

79. The cleaning method according to claim 70, wherein the cleaning layer comprises at least one metal selected from copper, vanadium, bismuth, molybdenum, manganese, iron, nickel, at platinum group metals, tin, and niobium, chromium, tungsten, rhenium, cobalt, and cerium, along with oxides of these metals and compounds composed of two or more of these metals and oxides.

80-81. (canceled)

82. The cleaning method according to claim 70, wherein the heating and air supply component is positioned beneath the top wall of the cooking chamber; at least the top wall of the cooking chamber is coated with the cleaning layer.

83. An air fryer, wherein comprising:
an air fryer body, the air fryer body having a cooking chamber; at least part of an inner wall of the cooking chamber is coated with a cleaning layer, the cleaning layer is configured to adsorb oil stains generated during cooking, and capable of catalyzing the decomposition of the oil stains;
a heating and air supply component, configured to supply hot air to the cooking chamber for cooking;
a memory, configured to store a program;
a processor, configured to execute the program stored in the memory to implement the method according to claim 57.

84. (canceled)
